(19) United States
(12) Patent Application Publication
(10) Pub. No.: US 2026/0339700 A1
(43) Pub. Date: Oct. 29, 2026

(54) Enabling Interoperability Between AI Agents

(71) Applicant: ServiceNow, Inc., Santa Clara, CA (US)

(72) Inventors: Sirigirireddy Buchireddy Sai Bhagyasree, Andhra Pradesh (IN); Rahul Kumar, Telangana (IN); Suhas Kalya Sridhar, Bengaluru (IN); Gaurav Goyal, San Jose, CA (US)

(21) Appl. No.: 19/189,530

(22) Filed: Apr. 25, 2025

(51) Int. Cl. G06F 9/48

(52) U.S. Cl. CPC G06F 9/4881

(57) ABSTRACT

A method includes obtaining an indication of capabilities of a first agent, where the first agent is associated with a first platform. The method includes obtaining an indication of capabilities of a second agent, where the second agent is associated with a second platform different from the first platform. The method includes obtaining a request defining a use case and identifying a set of tasks associated with the use case. The method includes determining, based on the capabilities of the first agent and the capabilities of the second agent, a first subset of the set of tasks and a second subset of the set of tasks. The method includes assigning the first subset of the set of tasks to the first agent and assigning the second subset of the set of tasks to the second agent.

### TECHNICAL FIELD

This disclosure relates to enabling interoperability between AI agents.

### BACKGROUND

Artificial intelligence (AI) agents are increasingly being deployed to automate and streamline complex tasks across various industries. These agents, powered by advancements in machine learning and natural language processing, offer the potential to significantly enhance productivity, reduce operational costs, and improve decision-making. From customer service chatbots to sophisticated data analysis tools, AI agents are capable of performing actions and making inferences that traditionally required human intervention. The use of multiple, specialized AI agents, working in concert, promises even greater capabilities, allowing for the tackling of multifaceted problems that exceed the scope of any single agent. However, agents are often developed on disparate technological foundations. For example, the agents may utilize different programming languages, data formats, and communication protocols. Being associated with disparate technological foundations hinders interoperability between the agents, reducing the efficiency by which the agents communicate, share information, and in general coordinate with each other.

### SUMMARY

One aspect of the disclosure provides a method for enabling interoperability between AI agents. The method includes obtaining an indication of capabilities of a first agent. The first agent is associated with a first platform. The method includes obtaining an indication of capabilities of a second agent. The second agent is associated with a second platform different from the first platform. The method also includes obtaining a request defining a use case and identifying a set of tasks associated with the use case. The method includes determining, based on the capabilities of the first agent and the capabilities of the second agent, a first subset of the set of tasks and a second subset of the set of tasks. The method also includes assigning the first subset of the set of tasks to the first agent and assigning the second subset of the set of tasks to the second agent.

Implementations of the disclosure may include one or more of the following optional features. Optionally, the method further includes performing, by the first agent, the first subset of the set of tasks, and assigning the second subset of the set of tasks to the second agent is configured to cause the second agent to perform the second subset of the set of tasks. In some implementations, the method further includes obtaining a registration request requesting registration of the second agent. The registration request may include one or more of a description of capabilities of the second agent or configuration information for accessing the second agent. In some examples, the method further includes obtaining a provider configuration associated with a provider of the second agent. The provider configuration may include one or more of application programming interface (API) endpoint information for the provider of the second agent, credentials for accessing the provider of the second agent, or associating the second agent with the provider configuration.

Optionally, the provider configuration defines a subflow configured to transform communications with the second agent from a format native to the second platform to a format native to the first platform. In some examples, assigning, to the second agent, the second subset of the set of tasks may include determining that the second agent fails to communicate via a predefined communication protocol and, based on determining that the second agent fails to communicate via the predefined communication protocol, communicating with the second agent via plain text. In some of these examples, the predefined communication protocol defines a first action indicating successful task completion, a second action indicating a request to terminate the second subset of the set of tasks, and a third action indicating a request for additional information to complete the second subset of the set of tasks.

In some implementations, the method further includes obtaining, from the second agent, a message to a user and communicating, on behalf of the second agent, the message to the user. Optionally, the method further includes determining a data access policy for the second agent and restricting data provided to the second agent based on the data access policy. Assigning, to the second agent, the second subset of the set of tasks may include communicating with the second agent asynchronously via a message queue.

Optionally, the second agent includes a trained neural network. In some examples, the method further includes selecting a first execution strategy for the first agent, the first execution strategy configured agents associated with the first platform and selecting a second execution strategy for the second agent, the second execution strategy configured agents associated with the second platform. In some of these examples, the second execution strategy manages external application programming interface (API) calls with the second agent. The use case may include a natural language description of a problem or goal.

Another aspect of the disclosure provides a system for enabling interoperability between AI agents. The system includes data processing hardware and memory hardware in communication with the data processing hardware. The memory hardware stores instructions that when executed on the data processing hardware cause the data processing hardware to perform operations. The operations include obtaining an indication of capabilities of a first agent. The first agent is associated with a first platform. The operations include obtaining an indication of capabilities of a second agent. The second agent is associated with a second platform different from the first platform. The operations also include obtaining a request defining a use case and identifying a set of tasks associated with the use case. The operations include determining, based on the capabilities of the first agent and the capabilities of the second agent, a first subset of the set of tasks and a second subset of the set of tasks. The operations also include assigning the first subset of the set of tasks to the first agent and assigning the second subset of the set of tasks to the second agent.

This aspect may include one or more of the following optional features. In some implementations, the operations further include obtaining a registration request requesting registration of the second agent. The registration request may include one or more of a description of capabilities of the second agent or configuration information for accessing the second agent. In some examples, the operations further include obtaining a provider configuration associated with a provider of the second agent. The provider configuration may include one or more of application programming interface (API) endpoint information for the provider of the second agent, credentials for accessing the provider of the second agent, or associating the second agent with the provider configuration.

Optionally, the provider configuration defines a subflow configured to transform communications with the second agent from a format native to the second platform to a format native to the first platform. In some examples, assigning, to the second agent, the second subset of the set of tasks may include determining that the second agent fails to communicate via a predefined communication protocol and, based on determining that the second agent fails to communicate via the predefined communication protocol, communicating with the second agent via plain text. In some of these examples, the predefined communication protocol defines a first action indicating successful task completion, a second action indicating a request to terminate the second subset of the set of tasks, and a third action indicating a request for additional information to complete the second subset of the set of tasks.

In some implementations, the operations further include obtaining, from the second agent, a message to a user and communicating, on behalf of the second agent, the message to the user. Optionally, the operations further include determining a data access policy for the second agent and restricting data provided to the second agent based on the data access policy. Assigning, to the second agent, the second subset of the set of tasks may include communicating with the second agent asynchronously via a message queue.

Optionally, the second agent includes a trained neural network. In some examples, the operations further include selecting a first execution strategy for the first agent, the first execution strategy configured agents associated with the first platform and selecting a second execution strategy for the second agent, the second execution strategy configured agents associated with the second platform. In some of these examples, the second execution strategy manages external application programming interface (API) calls with the second agent. The use case may include a natural language description of a problem or goal.

Another aspect of the disclosure provides a computer-readable medium for enabling interoperability between AI agents. The computer-readable medium has instructions that, when executed by data processing hardware, causes the data processing hardware to perform operations. The operations include obtaining an indication of capabilities of a first agent. The first agent is associated with a first platform. The operations include obtaining an indication of capabilities of a second agent. The second agent is associated with a second platform different from the first platform. The operations also include obtaining a request defining a use case and identifying a set of tasks associated with the use case. The operations include determining, based on the capabilities of the first agent and the capabilities of the second agent, a first subset of the set of tasks and a second subset of the set of tasks. The operations also include assigning the first subset of the set of tasks to the first agent and assigning the second subset of the set of tasks to the second agent.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for a system for enabling interoperability between AI agents.

FIG. 2 is a schematic view of an agent registration module of the system of FIG. 1.

FIG. 3 is an exemplary sequence diagram for the system of FIG. 1.

FIG. 4 is an exemplary flowchart for the system of FIG. 1.

FIG. 5 is an exemplary flowchart for a subflow of the system of FIG. 1.

FIG. 6 is a flowchart of an example arrangement of operations for a method of enabling interoperability between AI agents.

FIG. 7 is a schematic view of an example computing device that may be used to implement the systems and methods described herein.

Like reference symbols in the various drawings indicate like elements.

### DETAILED DESCRIPTION

The proliferation of artificial intelligence (AI) agents across diverse platforms presents a significant opportunity for automation and enhanced productivity. However, the current landscape of AI agents is highly fragmented. Different vendors develop and deploy AI agents on their own proprietary platforms, often using distinct development environments, programming languages, and communication protocols. This heterogeneity creates substantial obstacles to achieving true interoperability between these agents. For example, the lack of a standardized communication mechanism prevents agents from different providers from seamlessly exchanging information and collaborating on tasks.

This fragmentation leads to several critical limitations. First, organizations are often locked into a single vendor's ecosystem, limiting their ability to leverage the capabilities of agents from different providers. An organization might prefer an agent from a first vendor for scheduling, an agent from a second vendor for document processing, and an agent from a third vendor for internal workflow management. However, without a unified integration system, coordinating these agents to work together on a complex, multi-step task (e.g., scheduling a meeting that requires document preparation and approval) becomes exceedingly difficult, if not impossible. Manual intervention is often required to bridge the gaps between these disparate systems, negating many of the efficiency gains promised by AI automation.

Moreover, even when limited integration is possible through custom-built connectors or application programming interfaces (APIs), these solutions are often brittle, difficult to maintain, and do not scale effectively. Traditional platform integrations primarily focus on data exchange between applications, not on the dynamic, collaborative interactions required by AI agents working together as a team. AI agents require a much richer form of interaction, including the ability to exchange not just data, but also context, reasoning, and intermediate results. Furthermore, the security concerns are amplified when dealing with AI agents, as they may have access to sensitive data and the ability to make decisions that impact business operations. Existing integration methods do not adequately address the need for granular control over data access and sharing between AI agents from different providers. The goal of minimizing reliance on human (live) agents for task completion is also severely hampered by the lack of robust inter-agent communication and orchestration.

Implementations herein address these limitations by providing systems and methods for enabling interoperability between heterogeneous AI agents. The implementations include an agent framework controller that facilitates the registration of agents (e.g., agents of different platforms), built on different platforms, within a single system or orchestration platform. This registration process may involve obtaining a registration request that includes a description of the capabilities of an agent associated with a different platform and configuration information necessary for accessing the agent. This allows the system to understand the skills and access points of external agents. After the registration, the system may receive requests defining the use case. These use cases include a natural language description of a problem. The system (e.g., orchestrator and planner components) determines a set of tasks or subtasks required to fulfill the use case. Based on the registered capabilities of the agent, the system, in some implementations, assigns one or more of the tasks to the agent, using the provided configuration information to communicate with and direct the agent's actions.

The agent framework controller, in some examples, utilizes an orchestrator component to manage the workflow and coordinate the actions of both internal and external agents. This orchestrator breaks down complex, multi-turn tasks into tasks or subtasks, assigning them to the appropriate agents based on their registered proficiencies. The system may define a flexible communication protocol, with fallback to plain text, to accommodate agents that may not fully adhere to a strict communication contract. The system optionally incorporates robust data security controls, limiting the data shared with external agents and ensuring that sensitive information is protected. In some examples, the system employs personal authentication and user linking to maintain consistent identity context across different platforms.

These implementations offer many benefits, including advancements in computer and networking technology. For example, the system unlocks the potential for organizations to create truly heterogeneous AI agent teams, combining the strengths of agents from various providers to tackle complex tasks. This enhances flexibility and allows organizations to select the best tools for each specific job, rather than being constrained by platform limitations. As another example, by automating the orchestration and communication between agents, the system significantly reduces the need for human intervention, improving efficiency and reducing operational costs. Moreover, the improved efficiency, resulting from reduced reliance on manual data transfer and task switching between disparate systems, directly translates to a reduction in processor load and network bandwidth consumption.

In yet another example, the centralized management and security features provided by the system may enhance control and visibility over cross-platform AI agent interactions, mitigating the risks associated with data sharing and access. Specifically, the system's defined data access restrictions and data flow control mechanisms may improve data security by reducing the attack surface presented by interconnected, yet heterogeneous, agent systems. The structured communication protocol, including the fallback to plain text, provides a technically robust and adaptable method for inter-agent communication, improving the reliability and resilience of distributed computing systems. This is an improvement over conventional ad-hoc API integrations, by defining an explicit, formalized interaction model. Additionally, the system may be configured for both synchronous and asynchronous interactions, accommodating a wide range of use cases and communication patterns, utilizing, for example, message queues and callback URLs, further improving network resource management. The support for agent-initiated communication also enables proactive, event-driven workflows, further expanding the possibilities for AI-powered automation and fundamentally enhancing the capabilities of computer systems to handle complex, multi-agent tasks in a dynamic and efficient manner. Thus, these implementations represent a non-conventional approach to system integration, specific to the field of AI agents, that improves the functioning of computers managing these complex interactions.

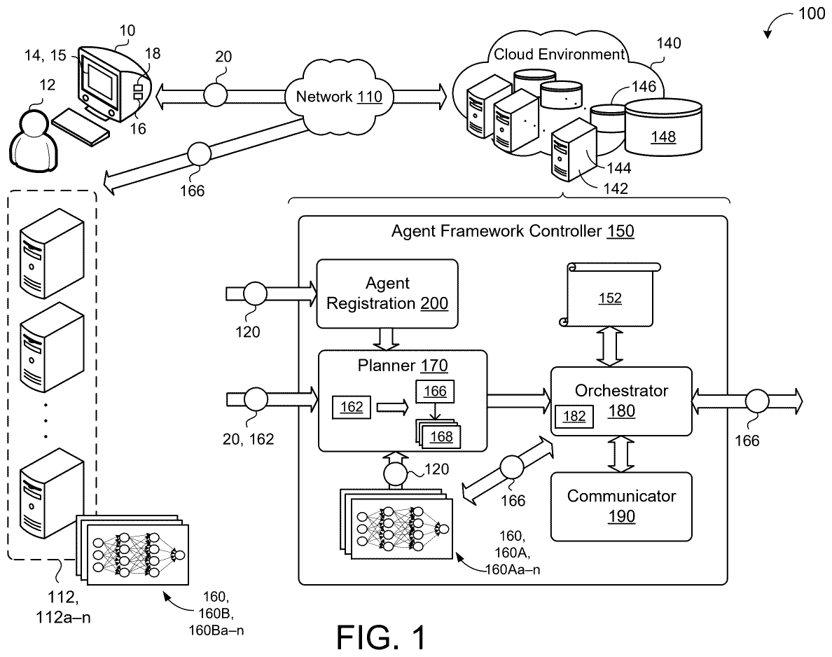

Referring to FIG. 1, in some implementations, an AI agent interoperability system 100 includes a primary platform 140 (e.g., an orchestration platform) in communication with one or more user devices 10 each associated with a respective user 12 via a network 110, such as the Internet, a local area network (LAN), a wide area network (WAN), a cellular network, or a wireless network. The user device(s) 10 may correspond to any computing device, such as a desktop workstation, a laptop workstation, or a mobile device (i.e., a smart phone). Each user device 10 includes computing resources 18 (e.g., data processing hardware) and/or storage resources 16 (e.g., memory hardware). The data processing hardware 18 executes a graphical user interface (GUI) 15 for display on a screen 14 in communication with the data processing hardware 18. The GUI 15 may be provided by a web browser, a web application, a native application, or a hybrid application running on the user device 10. The GUI 15 may allow the user to create, edit, manage, or test use cases 162 for various software applications or systems.

The primary platform, additionally or alternatively, is in communication with one or more external agent platforms 112, 112a-n (e.g., via the network 110 or a different network). The primary platform 140 may be a single computer, multiple computers, or a distributed system (e.g., a cloud environment) having scalable/elastic resources 142 including computing resources 144 (e.g., data processing hardware) and/or storage resources 146 (e.g., memory hardware). A data store 148 (i.e., a remote storage device) may be overlain on the storage resources 146 to allow scalable use of the storage resources 146 by one or more of the user devices 10 and/or external agent platforms 112 and/or the computing resources 144.

The primary platform 140 executes an agent framework controller 150 that manages interoperability between AI agents 160, 160a-n (e.g., neural networks, such as large language models (LLMs) or the like) residing on heterogeneous platforms 112, 140. The agent framework controller 150 may be a software application or module that is configured to generate and use a plurality of agents 160, including internal agents 160, 160A (i.e., agents 160 native to or internal to the primary platform 140) and external agents 160, 160B (i.e., agents 160 native to or internal to one or more external agent platforms 112) for use case 162 management. The use case 162 may include a natural language description of a problem or goal. The external agent platforms 112 may each execute any number of external agents 160B respectively.

The external agents 160B are associated with different platforms 112, 140 than the platform of the internal agent 160A. The agent framework controller 150 may interact with other software applications or modules that provide the GUI 15 or the use cases 162, such as a web server, a web application, a native application, or a hybrid application.

In some implementations, the agent framework controller 150 obtains a request 20 defining a use case 162. For example, the agent framework controller 150 receives the request 20 from a user device 10. The agent framework controller 150 obtains an indication of capabilities 120 (also referred to herein as proficiencies 120) of a first agent 160 (e.g., an internal agent 160A). The agent framework controller 150 obtains an indication of capabilities 120 of a second agent 160 (e.g., an external agent 160B), wherein the second agent 160 is associated with a second platform (e.g. an external agent platform 112a) different from the first platform (e.g., the primary platform 140). The agent framework controller 150 may obtain an indication of capabilities 120 for any number of agents 160 (internal or external to the primary platform 140).

The agent framework controller 150 executes a planner 170 that identifies a set of tasks 166 associated with the use case 162. The planner 170 may determine any number of subsets 168 from the set of tasks 166. For example, the planner 170 determines the subsets 168 based on the capabilities 120 of the agents 160 available to the agent framework controller 150. In an example, the agent framework controller 150 (e.g., the orchestrator 180 potentially utilizing suggestions from the planner 170) determines, based on the capabilities 120 of the first agent (e.g., the internal agent 160A) and the capabilities 120 of the second agent (e.g. the external agent 160B), a first subset 168 of the set of tasks 166 and a second subset 168 of the set of tasks. In this example, the agent framework controller 150 assigns the first subset 168 of the set of tasks 166 to the first agent (e.g., the internal agent 160A) and assigns the second subset 168 of the set of tasks 166 to the second agent (e.g., external agent 160B). The agent framework controller 150 may also assign other tasks of the set of tasks 166 to any other agents 160 (e.g., a third agent) as necessary or appropriate. In some examples, based on the assignment of the subset of tasks 168, the agents 160A, 160B perform their corresponding subset 168 of tasks 166. That is, the assignment from the agent framework controller 150 is configured to cause the agents 160A, 160B to perform the respective tasks 166.

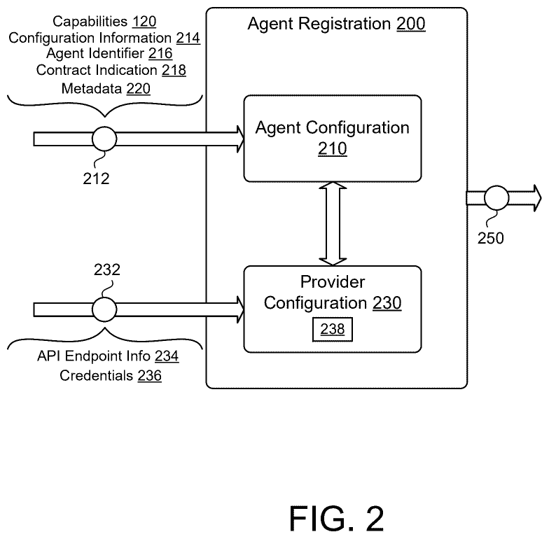

The agent framework controller 150 may include an agent registration module 200, an orchestrator 180, and/or a communicator 190. The agent registration module 200 may be configured to register external agents 160B with the primary platform 140 such that the primary platform 140 may integrate the functionality of the external agents 160B into the primary platform 140 in order to accomplish the use case 162. For example, and as discussed in more detail with regards to FIG. 2, the agent registration module 200 determines the capabilities 120 of the external agents and the means or methods of communicating with or accessing the external agents 160B. The communicator 190 may be configured to facilitate communications between the agent framework controller 150 (e.g., the orchestrator 180) and the user 12. For example, the communicator 190 is configured to cause prompts or other messages to be displayed to the user via the GUI 15 and to receive responses from the user 12. The responses may be provided to the other components the agent framework controller 150.

The orchestrator 180 manages the execution of the use case 162. The orchestrator 180 assigns tasks to both internal agents 160A and external agents 160B based on their registered capabilities (e.g., proficiencies). The orchestrator 180, in some implementations, selects an execution strategy 182 for each agent 160. For example, when the agent framework controller 150 is assigning subsets 168 of the set of tasks 166 to a first agent 160A and a second agent 160B for a particular use case 162, the orchestrator 180 selects a first execution strategy 182 for the first agent 160A configured for agents 160 associated with the first platform (e.g. the primary platform 140). The orchestrator 180 may also select a second execution strategy 182 for the second agent 160B configured for agents 160 associated with the second platform (e.g., an external agent platform 112). The second execution strategy 182 may manage external API calls with the second agent 160B.

The selection of an appropriate execution strategy 182 by the orchestrator 180 helps manage the diverse operational modes of internal and external agents 160. For example, an external agent execution strategy, which may be typically assigned to an external agent 160B, differs significantly from strategies used for internal agents 160A, such as a “react” strategy. The primary role of the external agent execution strategy may involve mediating communication with systems outside the primary platform 140. This entails initiating and managing external API calls directed towards the external agent platform 112, leveraging a configured subflow 238 (described in more detail with reference to FIG. 2) for necessary data transformations (e.g., request formatting, response parsing) and handling session management as required by the external system. The external agent execution strategy may operate on the principle that the core task execution logic, including the selection and use of specific tools or knowledge sources required by the agent 160B, and the associated decision-making processes, are handled within the external agent platform 112. In contrast, an internal execution strategy (e.g., react) may manage task execution within the primary platform 140, directly invoking internal tools and resources available to the internal agent 160A and overseeing the decision-making conducted by that agent on the primary platform 140 itself.

In some implementations, the orchestrator 180 establishes or verifies the communication protocol capabilities of external agents 160B dynamically. For example, the orchestrator 180 (e.g., during the initial interaction phase when first assigning a task subset 168 to an external agent 160B or as part of a distinct capability discovery protocol) attempts to directly negotiate the terms of communication with the external agent 160B. Alternatively or additionally, the orchestrator 180 may probe the external agent 160B to confirm its understanding and ability to adhere to the specified protocol structure, such as its capacity to recognize and appropriately use actions like complete, abort, or get more context, and provide responses formatted according to the protocol's defined fields (e.g., a message to the orchestrator or a message to the user). This potential dynamic negotiation or verification capability may supplement, or in some scenarios replace, the static configuration setting provided during registration, allowing the system 100 to adapt more flexibly to evolving or previously unknown external agent 160B capabilities and reducing the reliance on administrator configuration for ensuring protocol adherence.

In addition to or as an alternative to assigning tasks based on dynamically matching agent capabilities 120 to the requirements of a use case 162 or subtask 168, the agent framework controller 150 may support the configuration of predefined “agent teams” tailored to specific, complex use cases 162. An administrator, using a configuration interface (e.g., accessible via GUI 15 or REST APIs), may explicitly group selected internal agents 160A and external agents 160B into a dedicated team associated with a particular use case 162. When such a use case 162 is invoked, the orchestrator 180 restricts its task assignment considerations primarily to the agents 160 designated as members of that specific team, leveraging their combined capabilities as defined during the team setup.

This agent team approach is particularly beneficial for structured, multi-step workflows where the required combination of agent skills is well-defined in advance. From the perspective of the end-user 12, the user 12 interacts with the overarching use case 162, often unaware of the specific internal 160A and/or external agent 160B performing any given subtask within the team. The orchestrator 180 manages the delegation and communication flow among the team members, ensuring a seamless experience while executing the predefined logic of the use case 162 using the curated set of agents 160.

Optionally, the agent framework controller 150 supports making individual external agents 160B directly discoverable and invocable by users 12. For example, an administrator may configure a registered external agent 160B (e.g., via settings accessible through the GUI 15 or REST APIs), to be available (i.e., “discoverable”) through specific user interface channels. To enable natural language interaction for these discoverable agents, a corresponding “skill” is associated with the discoverable external agent 160B upon configuration.

When a user 12 enters a natural language utterance into a configured channel supporting discoverable agents, the primary platform 140 processes this input to identify an intent potentially corresponding to one of these standalone skills. This identification process may involve matching key elements of the user's utterance against the registered name, the description of capabilities 120 (i.e., proficiency), and/or other configured metadata 220 (FIG. 2) associated with the available discoverable external agents 160B. If a suitable match is found, indicating the user's intent to interact with a particular agent 160B for a relatively self-contained task or query, a dedicated “executor” component may be invoked specifically for handling this direct agent interaction. This executor component manages the invocation of the identified external agent 160B, utilizing the appropriate provider configuration 232 and subflow 238 to handle the request and response cycle, and facilitating the presentation of the agent's 160B output back to the user 12 via the GUI 15. This direct invocation via a skill and executor may provide a more immediate interaction path compared to the multi-step task decomposition and coordination that may be performed by the orchestrator 180 and planner 170 within the context of a predefined use case 162 involving an agent team.

The agent framework controller 150 (e.g., the orchestrator 180) facilitates communication between the system 100 and external agents 160B. In some examples, agent framework controller 150 attempts to use a defined communication protocol that includes specific actions (e.g., complete, abort, get more context) and message structures. The agent framework controller 150, when communicating the subset 168 of the set of tasks 166 to an external agent 160B, may determine that the external agent 160B fails to communicate via the predefined communication protocol. Based on determining that the external agent 160B fails to communicate via the predefined communication protocol, the agent framework controller 150 communicates with the external agent 160B using a fallback option. For example, the fallback option is plain text and, in this example, the agent framework controller 150 communicates with the external agent 160B via plain text instead of the predefined communication protocol. In some implementations, the agent framework controller 150 obtains, from external agents 160B, a message to a user 12 and communicates, on behalf of the external agent 160B, the message to the user 12. The communication may involve asynchronous communication via, for example, a message queue.

Furthermore, asynchronous communication may be facilitated through callback URLs, where an external agent platform 112 registers a specific endpoint, such as a webhook endpoint hosted on the primary platform 140, to which it can post the response once the task is completed. To manage the state and status of such asynchronous requests initiated by the primary platform 140, a dedicated data structure, such as a table, may be utilized within the primary platform 140 to track the request until a response is received or a timeout occurs.

The predefined communication protocol optionally allows for richer interaction and state management through additional structured fields. For example, an agent 160B adhering to the protocol may include a message_to_orchestrator field providing a human-readable explanation of its action or request. Optionally, it can include a thought field, offering insight into the agent's internal reasoning or decision-making process used to arrive at its response. Further optional fields include a perform_reflection flag, which can signal to the orchestrator 180 that a re-evaluation or reflection on the pending task queue might be beneficial based on the agent's findings, and a progress field, which allows the agent 160B to serialize and return relevant state information. This progress data can be stored by the primary platform 140 and provided back to the agent 160B if the interaction is paused and later resumed, facilitating continuity in multi-turn asynchronous tasks.

Furthermore, the communication protocol provides a structured mechanism for the external agent 160B to guide user interaction, mediated by the agent framework controller 150 (e.g., the orchestrator 180) and rendered on the primary platform 140 (e.g., via GUI 15). The protocol may define a message_to_user or equivalent field (i.e., a field including information to be provided to the user) not just as simple text, but as an array of structured objects. In these examples, each object within this array defines a specific UI element intended for presentation to or interaction with the user 12. For example, the external agent 160B may specify an OutputText object to display information, or an InputText object to solicit specific input from the user 12. This allows the external agent 160B to request necessary information or present formatted results in a controlled manner, enhancing the user experience even without direct access to the user interface.

In some implementations, the system accommodates scenarios where the nature of the information generated by the external agent 160B benefits from specific presentation formatting. For example, an external agent 160B processes data and concludes that presenting it in a tabular format would be clearest for the user 12, or that certain text should be emphasized using markdown conventions (e.g., bolding, italics, lists, links, etc.). To enable this without granting the external agent 160B direct control over the user interface, the communication protocol or the data returned by the agent 160B may include metadata or instructions indicating the desired format.

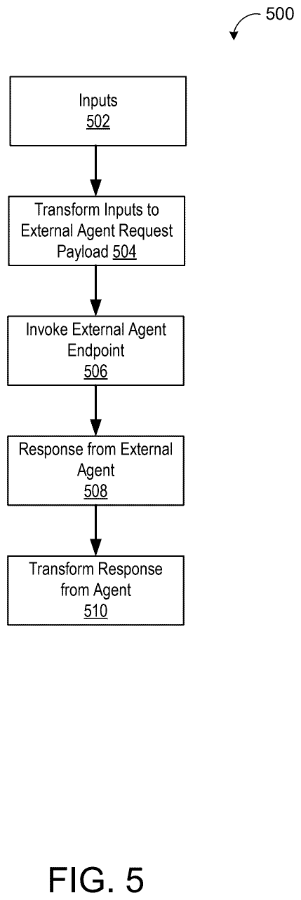

This formatting request is optionally transmitted as part of the agent's 160B response payload, potentially within the message_to_user structure or as associated metadata. The communicator 190, or a component responsible for rendering user interface elements based on agent responses within the primary platform 140, may be configured to interpret these formatting requests. Upon receiving a response containing such a request (e.g., a flag indicating “display_as_table” or content formatted using standard markdown syntax), the communicator 190 attempts to render the associated message_to_user content accordingly within the GUI 15. This allows the external agent 160B to influence the presentation for improved clarity and user experience, while the primary platform 140 retains control over the actual UI rendering and security. The transformation logic within the provider-specific subflow 238 may also play a role in identifying or standardizing these formatting requests during response transformation (FIG. 5).

In some implementations, the agent framework controller 150 enforces one or more data access policies 152. For example, the agent framework controller 150 determines a data access policy 152 for an agent 160 (e.g., an external agent 160B), and restricts data provided to the agent 160 based on the data access policy 152. The agent framework controller 150 ensures that sensitive information within the primary platform 140 is not improperly exposed to external agent platforms 112 or agents 160B.

The agent framework controller 150, such as when interacting with external agents 160B via the relevant execution strategy 182, may perform data trimming operations before transmitting information. This addresses the security concern that internal agents 160A and/or the orchestrator 180 may operate with extensive context derived from multi-turn interactions, access comprehensive internal knowledge graphs containing potentially proprietary organizational data, and utilize long-term memory stores capturing historical user interactions or learned preferences maintained within the primary platform 140. To mitigate the risk of exposing sensitive internal data to external agent platforms 112, the agent framework controller 150, optionally guided by the applicable data access policy 152, selectively reduces or filters this information payload.

For example, the conversational history provided as context to an external agent 160B may be truncated to include only the immediately relevant preceding turns necessary for the assigned subtask (i.e., a subset task 166). Similarly, access to internal knowledge graphs might be restricted, providing only specific, non-sensitive nodes or subgraphs explicitly required for the task, rather than exposing the entire graph structure or content. Furthermore, information residing in the primary platform's long-term memory related to the user or prior interactions may be entirely withheld or heavily filtered before being included in the request sent to the external agent 160B. The specific degree and nature of this trimming may be configured within the data access policy 152, allowing administrators to balance the functional requirements of the external agent 160B with the security posture of the primary platform 140.

Beyond restricting the data shared, ensuring that external agents 160B operate under the correct user context is often important, particularly when actions performed on the external agent platform 112 require user-specific permissions or access personalized data. To address this, the agent framework controller 150, in some examples, further incorporates mechanisms for personal authentication and cross-platform user identity linking. For example, when a user 12 interacts with the primary platform 140, their identity is authenticated through standard platform procedures.

Subsequently, the system 100 facilitates the linking of the authenticated user's identity on the primary platform 140 with their corresponding identity on the relevant external agent platform 112. This linking may be established through various techniques, such as pre-configuration by an administrator, user-consented authorization flows (e.g., OAuth), or the secure exchange of identity tokens based on federated identity standards. Successfully linking user identities ensures that when the orchestrator 180 assigns a task subset 168 to an external agent 160B, the request is processed by the external agent platform 112 under the appropriate authority and permissions of the specific end-user 12, maintaining consistent security context and enabling personalized experiences across the heterogeneous system.

Referring to FIG. 2, in some implementations, the agent registration module 200 facilitates the registration of external agents 160B with the primary platform 140. The agent registration module 200 includes an agent configuration module 210. The agent configuration module 210 may receive a registration request 212 (e.g., from a user 12) requesting registration of one or more external agents 160B. The registration request 212 includes, for example, a description of the capabilities 120 of the external agent 160B. The capabilities 120 describe the proficiency of the external agent 160B, acting as a skill definition for task assignment by the orchestrator 180. The registration request 212 additionally or alternatively includes configuration information 214 for accessing the external agent 160B. The configuration information 214 may include an external agent identifier 216. The external agent identifier 216, in some examples, includes a unique identifier for the external agent 160B on the external agent platform 112. Optionally, the configuration information 214 includes an indication 218 of whether the external agent 160B will follow a defined communication protocol (i.e., a contract indication 218). The configuration information 214, in some examples, includes metadata 220, which may be in JSON format. The metadata 220 stores additional, agent-specific information about the external agent 160B.

In some implementations, the agent registration module 200 includes a provider configuration module 230. The provider configuration module 230, optionally, obtains a provider configuration 232 associated with an external agent platform 112 of the external agent 160B (i.e., a provider of the agent 160B). The provider configuration 232 may be prerequisite for registering individual agents 160 from the external agent platform 112. Multiple agents 160B may share a single provider configuration 232. For example, each agent 160B associated with a particular external agent platform 112 may share the same provider configuration 232.

The provider configuration 232 includes, in some examples, API endpoint information 234 for the external agent platform 112 and/or provider of the external agent 160B. The API endpoint information 234 specifies the API endpoints for interacting with the external agent platform 112 and establishes a communication channel. The provider configuration 232 optionally includes credentials 236 for accessing the provider or external agent platform 112 of the agent 160B. The credentials 236 may include connection and credential aliases, which the agent registration module 200 stores securely. The provider configuration module 230 may determine or define a subflow 238 configured to transform communications with the external agent 160B from a format native to the external agent platform 112 to a format native to the primary platform 140. The subflow 238 is responsible for transforming requests into the provider's expected format and transforming responses back into the primary platform's format.

In some examples, the provider configuration 232 encompasses provider-specific settings for establishing and maintaining successful communication between the primary platform 140 and the external agent platform 112. This can include, for example, specific version information pertaining to the external agent platform 112 or its relevant APIs. Capturing version details helps ensure compatibility, as different versions of a provider's platform or API may have distinct requirements, functionalities, or data schemas that the primary platform 140 must account for when formatting requests or interpreting responses via the subflow 238. Other provider-specific settings stored within the provider configuration 232 may include parameters defining preferred data exchange formats, specific authentication nuances beyond basic credentials (e.g., required headers or token types), required communication flags, or operational constraints like rate limits, or any other information helpful for the primary platform 140 to interact correctly and reliably with external agents 160B hosted on that particular external agent platform 112.

The agent configuration module 210 and/or the provider configuration module 230 associates the external agent 160B with the provider configuration 232. The agent registration module 200 may store agent configuration data in specific tables, for instance, an external agent configuration table and an agent table. The agent registration module 200, in some examples, controls the availability 250 of the registered external agents 160B on the primary platform 140. The agent registration module 200 may manage this availability 250 through a display setting (e.g., true/false) for specific channels.

Furthermore, in typical implementations, the registration of an external agent 160B establishes its availability and configuration specifically within the context of a single instance of the primary platform 140. This registration scope means that an external agent 160B registered in one instance is generally not automatically available or shared with other distinct instances of the primary platform 140, even if those instances are managed by the same organization or hosted within the same data center infrastructure. Consequently, even when an external agent provider 112 makes an agent generally available, an administrator for each specific primary platform instance 140 may be required to explicitly perform the registration process, potentially including instance-specific permissions or configuration steps, to enable the use of that external agent 160B within their environment. Optionally, alternative registration scopes may be implemented, such as allowing registration sharing across a defined set of trusted instances, depending on security requirements and system architecture, based on the requirements for maintaining data isolation and administrative control.

In some implementations, the agent registration module 200 configures user access roles. An administrator (e.g., a user 12) may configure the agent registration module 200 via a user interface (e.g., a settings page) and/or through REST APIs. The agent registration module 200 may expose APIs to allow third-party providers (e.g., external agent platforms 112) to register agents 160B programmatically. Once the agent registration module 200 registers an agent 160B, that agent 160B may be available for use in multiple projects and scenarios within a single instance of the primary platform 140 (i.e., the instance the user 12 or the requestor of the request 20 is associated with). Alternatively, the agent 160B may be available across all instances of the primary platform 140.

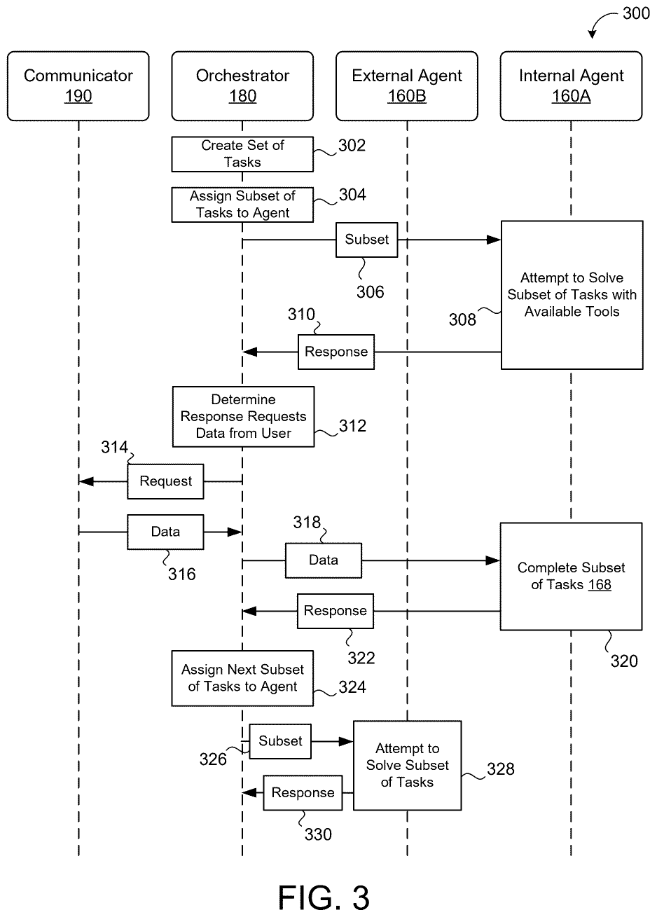

Referring now to FIG. 3, a sequence diagram 300 illustrates an example workflow managed by the agent framework controller 150, specifically involving interactions between the orchestrator 180, the communicator 190, an internal agent 160A operating on the primary platform 140, and an external agent 160B operating on an external agent platform 112. The sequence begins when the orchestrator 180, optionally in conjunction with the planner 170 (FIG. 1), creates a set of tasks 166 required to fulfill a specific use case 162 (Step 302). Based on the capabilities 120 of the available agents 160, the orchestrator 180 assigns a subset 168 of the tasks 166 to an appropriate agent 160 (Step 304).

In this example, the orchestrator 180, based on the capabilities 120 and the use case 162, assigns a first subset 168 of tasks to the internal agent 160A (Step 306). The internal agent 160A attempts to solve this subset 168 using its available tools and resources within the primary platform 140 (Step 308). The internal agent 160A then sends a response back to the orchestrator 180 (Step 310). In this scenario, the orchestrator 180 determines that the response indicates a need by the internal agent 160A for additional data, specifically data required from the user 12 (Step 312).

To obtain the necessary information, the orchestrator 180 sends a request to the communicator 190 (Step 314). The communicator 190, which facilitates interactions with other entities, such as the user 12 (e.g., via the GUI 15), obtains the required data and sends it back to the orchestrator 180 (Step 316). The orchestrator 180 then sends or forwards this data to the internal agent 160A (Step 318). With the necessary data received, the internal agent 160A completes its assigned subset 168 of tasks 166 (Step 320) and sends a final response, which may indicate completion, back to the orchestrator 180 (Step 322).

Following the completion of the first subset 168, the orchestrator 180 proceeds with the workflow by assigning the next subset 168 of tasks 166 (Step 324). Based on the capabilities 120 required for this subset 168, the orchestrator 180 assigns it to the external agent 160B (Step 326). The orchestrator 180 communicates this assignment to the external agent 160B, optionally utilizing a subflow 238 defined in the provider configuration 232 and/or the selected execution strategy 182 for external agents. The external agent 160B, operating on its respective external platform 112, attempts to solve its assigned subset 168 of tasks 166 (Step 328). Finally, the external agent 160B sends a response back to the orchestrator 180 (Step 330). This response may conform to the defined communication protocol, including actions like ‘complete’ or ‘get more context’, or it may be in plain text if the agent 160B does not follow the protocol, requiring interpretation by the orchestrator 180. The orchestrator 180 continues managing the workflow based on the responses received from all involved agents 160 until the use case 162 is fulfilled or terminated.

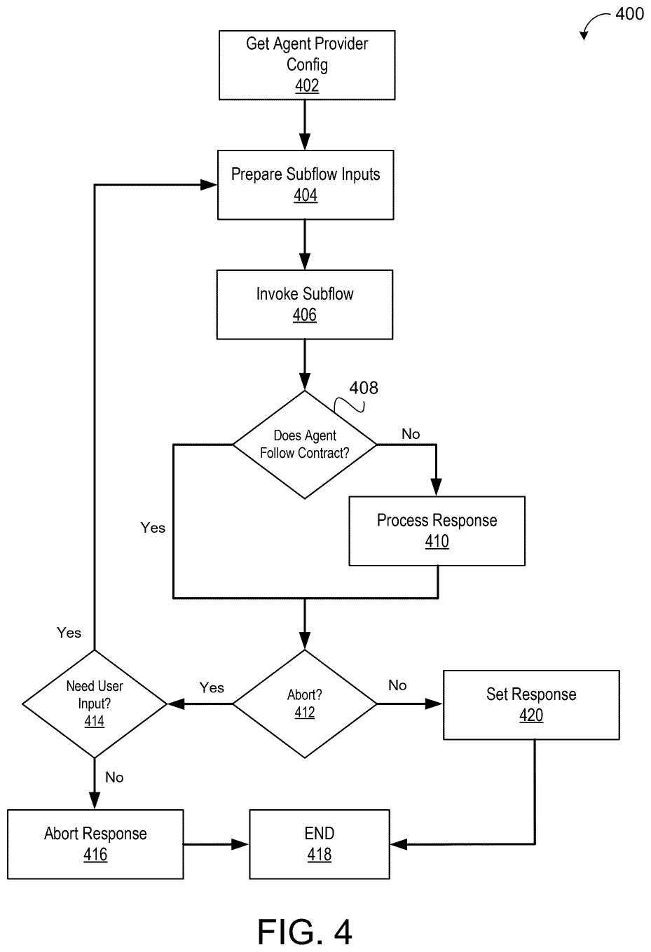

FIG. 4 illustrates an example flowchart 400 for handling communication with an external agent 160B as part of the execution strategy 182 invoked by the orchestrator 180 (FIG. 1). The flowchart 400 includes steps involved in sending a task or request to the external agent 160B and processing its response, including handling communication protocol variations.

The flowchart 400 begins by obtaining the relevant agent provider configuration 232 for the target external agent 160B (Step 402). This configuration 232 may include information such as API endpoints 234 and credentials 236 required to interact with the external agent platform 112 and/or external agent 160B. Using this configuration 232 and the details of the assigned task subset 168, the system prepares the inputs for the provider-specific communication subflow 238 (Step 404). This subflow 238 is configured to provide the translation between the format of the primary platform 140 and the native format of the external agent platform 112.

Next, the system invokes the prepared subflow 238 (Step 406). This action initiates the communication with the external agent 160B, sending the task request and any accompanying data according to the specifications defined in the provider configuration 232 and subflow 238. Once a response is received from the external agent 160B, the system determines if the agent 160B is following the predefined communication protocol or contract (Decision 408). This determination may be based on an initial configuration setting (e.g., contract indication 218 from FIG. 2) or by analyzing the structure of the received response.

If the agent 160B does not follow the contract (“No” path from Decision 408), the system proceeds to process the response using alternative means (Step 410). This may involve interpreting the response as plain text and attempting to understand the agent's intention or result. When the agent 160B does follow the contract (i.e., the “Yes” path from Decision 408), the response is processed according to the protocol's defined structure.

Following response processing (either from Step 410 or the “Yes” path of Decision 408), the system checks whether the response indicates an “abort” action, signaling a request from the external agent 160B to terminate the current task or workflow (Decision 412). If an abort is requested (“Yes” path from Decision 412), the flowchart 400 determines whether user input is required to proceed with the abort (Decision 414). If no user input is needed (“No” path from Decision 414), an abort response is formulated or processed (Step 416), and the process 400 concludes (Step 418). The path requiring user input (“Yes” path from Decision 414) may involve invoking the communicator 190 to interact with the user 12 via the GUI 15 (FIG. 1).

If the response does not indicate an abort (“No” path from Decision 412), the system proceeds to set the response (Step 420). This involves updating the status of the assigned task subset 168 based on the agent's response (e.g., complete, get more context, etc.), storing any relevant data or state provided by the agent (e.g., a “message_to_user” state or a “progress” state), and preparing for the next step in the overall use case 162 orchestration managed by the orchestrator 180. After setting the response, this communication sub-process concludes (Step 418).

Referring now to FIG. 5, an example flowchart 500 illustrates a communication subflow, such as the subflow 238 of the provider configuration 232 (FIG. 2) and invoked during the process described in FIG. 4 (e.g., at Step 406). This subflow details the steps involved in sending a request to and receiving a response from an external agent 160B operating on an external agent platform 112. The subflow begins by receiving inputs (Step 502). These inputs may include the specific task subset 168 assigned by the orchestrator 180 (FIG. 1), necessary context or data permissible under the data access policy 152, and relevant details from the agent configuration or provider configuration 232, such as authentication credentials 236.

Next, the subflow transforms these inputs into a request payload suitable for the external agent 160B (Step 504). This transformation process, as defined within the subflow 238 logic associated with the provider configuration 232, converts the data and instructions from the format native to the primary platform 140 (FIG. 1) into the specific format expected by the external agent platform 112 or the target external agent 160B. This ensures the request is understandable by the receiving system.

Using the transformed request payload and the API endpoint information 234 (FIG. 2) specified in the provider configuration 232, the subflow then invokes the external agent endpoint (Step 506). This step initiates the actual communication, typically an API call, from the primary platform 140 across the network 110 (FIG. 1) to the external agent platform 112, effectively delivering the task request to the external agent 160B.

Subsequently, the subflow receives a response from the external agent 160B via its platform 112 (Step 508). This response represents the outcome of the external agent's 160B attempt to process its assigned task subset 168. The response may include results, status updates, requests for more information (e.g., triggering a “get more context” action if following the protocol), or error messages, all formatted according to the external agent platform's 112 native communication structure.

The subflow transforms the received response (Step 510). This step mirrors the initial transformation but in reverse: it converts the response data from the format native to the external agent platform 112 back into a format that is native to and can be processed by the primary platform 140, such as the orchestrator 180 or communicator 190. The output of this subflow (i.e., the transformed response) may then be used by the calling process (e.g., as depicted in FIG. 4), to determine the next steps in the overall use case 162 execution.

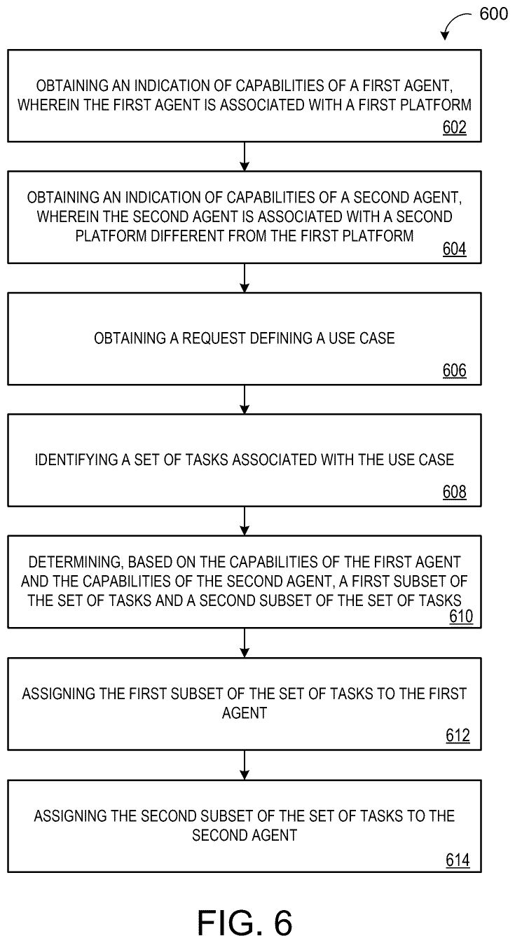

FIG. 6 is a flowchart of an exemplary arrangement of operations for a method 600 of enabling interoperability between agents 160 (e.g., between internal agents 160A and external agents 160B) residing on heterogeneous platforms (e.g., a primary platform 140 and external agent platforms 112). The method 600, executed for example by the agent framework controller 150 within the primary platform 140, begins at operation 602, which includes obtaining an indication of capabilities 120 of a first agent 160 (e.g., an internal agent 160A). The first agent 160A is associated with a first platform (e.g., the primary platform 140). At operation 604, the method 600 includes obtaining an indication of capabilities 120 of a second agent 160 (e.g., an external agent 160B). The second agent 160B is associated with a second platform (e.g., an external agent platform 112) different from the first platform 140. These capabilities 120 (or proficiencies) may be obtained, particularly for external agents 160B, through a registration process managed by the agent registration module 200, optionally involving a registration request 212 containing capability descriptions and configuration information 214.

At operation 606, the method 600 includes obtaining a request 20 defining a use case 162, which may be a natural language description of a problem or goal received from a user 12. At operation 608, the method 600 includes identifying (e.g., using the planner 170) a set of tasks 166 associated with the use case 162. The method 600, at operation 610, includes determining, based on the obtained capabilities 120 of the first agent 160A and the second agent 160B (and optionally one or more other registered agents 160), a first subset 168 of the set of tasks 166 and a second subset 168 of the set of tasks 166. This determination is typically performed by the orchestrator 180 in conjunction with the planner 170. At operation 612, the method 600 includes assigning (e.g., via the orchestrator 180) the first subset 168 of the set of tasks 166 to the first agent 160A and, at operation 614, assigning the second subset 168 of the set of tasks 166 to the second agent 160B. Assigning tasks to the external agent 160B may involve selecting a specific execution strategy 182 (such as an external agent strategy) that manages communication via external APIs, optionally using provider configuration 232 including API endpoints 234 and credentials 236 and/or transforming communication formats using a subflow 238.

This arrangement, where tasks 166 derived from a use case 162 are intelligently distributed across agents 160 from different platforms 112, 140 based on their registered capabilities 120, provides numerous technical advantages and represents an improvement over conventional system integration approaches. By obtaining capabilities and using them to assign task subsets, the method 600 directly addresses the technical problem of AI agent fragmentation. These implementations enable the creation of heterogeneous agent teams (e.g., teams composed of agents 160A, 160B originating from different platforms 112, 140), thereby allowing the system to utilize the specific technical capabilities 120 of diverse agents 160 by assigning task subsets 168 to the agent 160 determined to be most proficient for those specific tasks within a unified orchestration framework managed by the primary platform 140. This contrasts sharply with prior methods requiring brittle, custom integrations or limiting users to a single vendor's ecosystem. The centralized orchestration, facilitated by the agent framework controller 150, planner 170, and orchestrator 180, automates the decomposition of complex use cases 162 and the coordination of multi-turn interactions, thereby minimizing reliance on manual intervention and human agents.

Moreover, as compared with other techniques, the method 600 (and the system 100 implementing it) offers technical benefits related to computing resource efficiency and security, directly improving the functioning of the underlying computer systems. For example, automating the task assignment and inter-agent communication reduces the manual effort and context switching previously required, leading to improved overall efficiency, reduced operational costs, and consequently, a reduction in processor load and network bandwidth consumption compared to disjointed, manual processes. The implementations may include enforcing data access policies 152 when assigning tasks to external agents 160B and managing data flow, which helps address the technical challenge of secure data exchange with external AI systems, mitigating risks specific to AI agent interactions that differ from traditional integrations. As additional examples, the system may employ a defined communication protocol with fallback to plain text, handle mediated user communication, support both synchronous and asynchronous communication, and use distinct execution strategies 182, which contribute to a robust, flexible, and technically advanced solution for managing distributed AI workloads. This approach enhances the reliability and resilience of the distributed computing system and fundamentally improves the capability of the computer system 100 to manage complex, multi-agent tasks efficiently and securely.

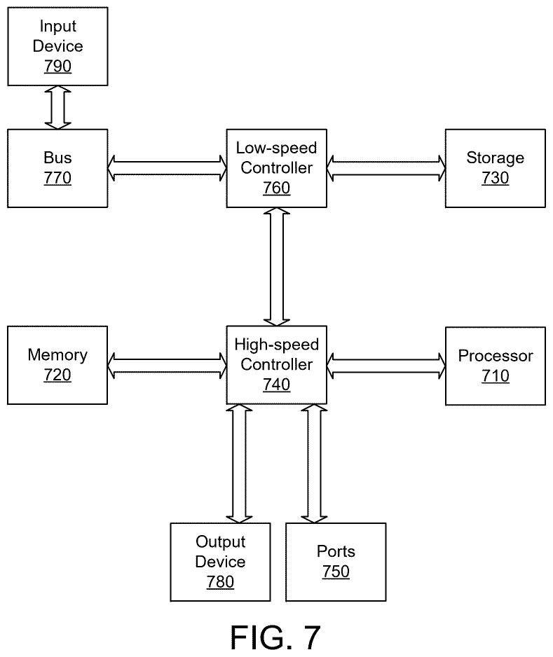

FIG. 7 is a schematic view of an example computing device 700 that may be used to implement the systems and methods described in this document. The computing device 700 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 700 includes a processor 710, memory 720, a storage device 730, a high-speed interface/controller 740 connecting to the memory 720 and high-speed expansion ports 750, and a low-speed interface/controller 760 connecting to a low-speed bus 770 and a storage device 730. Each of the components 710, 720, 730, 740, 750, and 760, are interconnected using various busses, and may be mounted on a common motherboard or in other manners as appropriate. The processor 710 can execute instructions for performing operations within the computing device 700, including instructions stored in the memory 720 or on the storage device 730 to display graphical information for a graphical user interface (GUI) on an external input/output device, such as display 780 coupled to high-speed interface 740. In other implementations, multiple processors and/or multiple buses may be used, as appropriate, along with multiple memories and types of memory. Also, multiple computing devices 700 may be connected, with each device providing portions of the necessary operations (e.g., as a server cluster, a group of blade servers, or a multi-processor system).

The memory 720 stores information within the computing device 700. The memory 720 may be a non-transitory computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs).

Examples of volatile memory include, but are not limited to, random access memory (RAM), dynamic random-access memory (DRAM), static random-access memory (SRAM), phase change memory (PCM) as well as disks or tapes.

The storage device 730 is capable of providing mass storage for the computing device 700. In some implementations, the storage device 730 is a non-transitory computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 720, the storage device 730, or memory on processor 710.

The high-speed controller 740 manages bandwidth-intensive operations for the computing device 700, while the low-speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port or input device 790. The low-speed expansion port 790, which may include various communication ports (e.g., USB, Bluetooth, Ethernet, wireless Ethernet), may be coupled to one or more input/output devices, such as a keyboard, a pointing device, a microphone, a touch screen, a scanner, or a networking device such as a switch or router, e.g., through a network adapter.

The computing device 700 may be implemented in a number of different forms, as shown in the figure. For example, it may be implemented as a standard server or multiple times in a group of such servers, as a laptop computer, or as part of a rack server system.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term “non-transitory computer-readable signal” refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an “application,” an “app,” a “program,” or a “service.” Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
obtaining an indication of capabilities of a first agent, wherein the first agent is associated with a first platform;
obtaining an indication of capabilities of a second agent, wherein the second agent is associated with a second platform different from the first platform;
obtaining a request defining a use case;
identifying a set of tasks associated with the use case;
determining, based on the capabilities of the first agent and the capabilities of the second agent, a first subset of the set of tasks and a second subset of the set of tasks;
assigning the first subset of the set of tasks to the first agent; and
assigning the second subset of the set of tasks to the second agent.

2. The method of claim 1, further comprising performing, by the first agent, the first subset of the set of tasks, wherein assigning the second subset of the set of tasks to the second agent is configured to cause the second agent to perform the second subset of the set of tasks.

3. The method of claim 1, further comprising obtaining a registration request requesting registration of the second agent, the registration request comprising:
a description of capabilities of the second agent; and
configuration information for accessing the second agent.

4. The method of claim 1, further comprising:
obtaining a provider configuration associated with a provider of the second agent, the provider configuration comprising:
application programming interface (API) endpoint information for the provider of the second agent; and
credentials for accessing the provider of the second agent; and
associating the second agent with the provider configuration.

5. The method of claim 4, wherein the provider configuration defines a subflow configured to transform communications with the second agent from a format native to the second platform to a format native to the first platform.

6. The method of claim 1, wherein assigning, to the second agent, the second subset of the set of tasks comprises:
determining that the second agent fails to communicate via a predefined communication protocol; and
based on determining that the second agent fails to communicate via the predefined communication protocol, communicating with the second agent via plain text.

7. The method of claim 6, wherein the predefined communication protocol defines:
a first action indicating successful task completion;
a second action indicating a request to terminate the second subset of the set of tasks; and
a third action indicating a request for additional information to complete the second subset of the set of tasks.

8. The method of claim 1, further comprising:
obtaining, from the second agent, a message to a user; and
communicating, on behalf of the second agent, the message to the user.

9. The method of claim 1, further comprising:
determining a data access policy for the second agent; and
restricting data provided to the second agent based on the data access policy.

10. The method of claim 1, wherein assigning, to the second agent, the second subset of the set of tasks comprises communicating with the second agent asynchronously via a message queue.

11. The method of claim 1, wherein the second agent comprises a trained neural network.

12. The method of claim 1, further comprising:
selecting a first execution strategy for the first agent, the first execution strategy configured agents associated with the first platform; and
selecting a second execution strategy for the second agent, the second execution strategy configured agents associated with the second platform.

13. The method of claim 12, wherein the second execution strategy manages external application programming interface (API) calls with the second agent.

14. The method of claim 1, wherein the use case comprises a natural language description of a problem or goal.

15. A system comprising:
data processing hardware; and
memory hardware in communication with the data processing hardware, the memory hardware storing instructions that when executed on the data processing hardware cause the data processing hardware to perform operations comprising:
obtaining an indication of capabilities of a first agent, wherein the first agent is associated with a first platform;
obtaining an indication of capabilities of a second agent, wherein the second agent is associated with a second platform different from the first platform;
obtaining a request defining a use case;
identifying a set of tasks associated with the use case;
determining, based on the capabilities of the first agent and the capabilities of the second agent, a first subset of the set of tasks and a second subset of the set of tasks;
assigning the first subset of the set of tasks to the first agent; and
assigning the second subset of the set of tasks to the second agent.

16. The system of claim 15, wherein the operations further comprise obtaining a registration request requesting registration of the second agent, the registration request comprising:
a description of capabilities of the second agent; and
configuration information for accessing the second agent.

17. The system of claim 15, wherein the operations further comprise:
obtaining a provider configuration associated with a provider of the second agent, the provider configuration comprising:
application programming interface (API) endpoint information for the provider of the second agent; and
credentials for accessing the provider of the second agent; and
associating the second agent with the provider configuration.

18. The system of claim 17, wherein the provider configuration defines a subflow configured to transform communications with the second agent from a format native to the second platform to a format native to the first platform.

19. The system of claim 15, wherein assigning, to the second agent, the second subset of the set of tasks comprises:
determining that the second agent fails to communicate via a predefined communication protocol; and
based on determining that the second agent fails to communicate via the predefined communication protocol, communicating with the second agent via plain text.

20. A computer-readable medium having instructions that, when executed by data processing hardware, causes the data processing hardware to perform operations comprising:
obtaining an indication of capabilities of a first agent, wherein the first agent is associated with a first platform;
obtaining an indication of capabilities of a second agent, wherein the second agent is associated with a second platform different from the first platform;
obtaining a request defining a use case;
identifying a set of tasks associated with the use case;
determining, based on the capabilities of the first agent and the capabilities of the second agent, a first subset of the set of tasks and a second subset of the set of tasks;
assigning the first subset of the set of tasks to the first agent; and
assigning the second subset of the set of tasks to the second agent.
